(19) United States
(12) Patent Application Publication
(10) Pub. No.: US 2016/0166975 A1
(43) Pub. Date: Jun. 16, 2016

(54) METHOD FOR REMOVING ACID GASES FROM A FLUID FLOW CONTAINING NITROGEN OXIDES

(71) Applicant: BASF SE, Ludwigshafen (DE)

(72) Inventors: Georg SIEDER, Bad Dürkheim (DE); Iven CLAUSEN, Mannheim (DE); Javier GARCIA PALACIOS, Köln (DE); Gustavo Adolfo LOZANO MARTINEZ, Ludwigshafen (DE)

(21) Appl. No.: 14/902,670

(22) PCT Filed: Jul. 4, 2014
(86) PCT No.: PCT/EP2014/064309

§ 371 Date: Jan. 4, 2016

(30) Foreign Application Priority Data
Jul. 5, 2013 (EP) 13175316.2

(51) Int. Cl. B01D 53/14

(52) U.S. Cl. CPC B01D 53/1425; B01D 53/1456; B01D 2252/204

(57) ABSTRACT

A process for separating off acid gases from a nitrogen oxide-comprising fluid stream, wherein a) the fluid stream is brought into contact in an absorption zone with an aqueous absorbent which comprises at least one amino group-comprising compound, wherein a deacidified fluid stream is obtained, b) the deacidified fluid stream is brought into contact in at least one scrubbing zone with an aqueous scrubbing liquid and a de-aminated deacidified fluid stream is obtained, wherein the scrubbing liquid is recycled via at least one scrubbing zone, c) overflow from the at least one scrubbing zone is treated with UV light, and d) the UV-treated overflow is combined with the absorbent. The process permits the efficient degradation of the nitrosamines present in the absorbent.

For separating off acid gases from fluid streams, frequently amine-comprising aqueous absorbents are used. The fluid stream can be e.g. flue gas which originates from the oxidation of organic substances, which proceeds e.g. in fossil power plants. Acid gases are absorbed by the reversible reaction with the amine present in the aqueous absorbent. Frequently, primary and/or secondary amines are used.

Flue gases, in addition to N₂, O₂, CO₂, also comprise nitrogen oxides, NOₓ, which substantially comprise nitrogen monoxide, NO, and nitrogen dioxide, NO₂. Even flue gases which have been subjected to a process for reducing the nitrogen oxide concentration still comprise about 100-150 mg of NOₓ per cubic meter. NO is usually the main component of the nitrogen oxides present in flue gases. Generally, the ratio NO₂/NO increases with increasing oxygen content of the flue gas. Therefore, in flue gases from gas power plants having an oxygen content of 10-16% by volume, a higher NO₂ content may be expected than in flue gases from coal power plants having an oxygen content of 3-7% by volume.

NO₂ is markedly more water soluble than NO. NO₂ is absorbed in the aqueous absorbent and there reacts with water, with disproportionation to form nitrate and nitrite. Nitrite can react with secondary amines to form nitrosamines; many nitrosamines are carcinogenic.

Even in absorbents that originally do not contain secondary amines, via thermal or oxidative degradation of the absorbent, formation of secondary amines can occur, and thus formation of nitrosamines can occur.

Nitrosamines can accumulate in the absorbent, pass over into the fluid stream from the absorbent and be released via the fluid stream. The handling of absorbent loaded with nitrosamine is associated with great expenditure.

It is known that nitrosamines can be degraded by treatment with UV light. Nitrosamines absorb UV light preferentially in the wavelength range from 225 to 250 nm. The effectiveness of the degradation of dissolved nitrosamines by UV light is dependent on the absorption behavior of the nitrosamine-comprising solution. If the aqueous solution, in addition to nitrosamines, comprises substantial amounts of amines, the depth of penetration of the UV light in the wavelength range from 225 to 250 nm is low and nitrosamine which is not situated in surface-close regions of the absorption solution is not accessible to the UV light. Therefore, nitrosamine in the absorption solution is only effectively degraded if the UV light acts on the solution over a very large surface area.

WO 2011/100801 A1 discloses a process for separating off CO₂ from a CO₂-comprising gas stream, wherein the gas stream is brought into contact with an amine-based CO₂ scrubbing solution and the amine-based CO₂ scrubbing solution is irradiated with light of a wavelength of 190-450 nm. The scrubbing solutions include liquid phases in any plant sections such as e.g. scrubbing water which is used for retaining amines. The irradiation of a defined scrubbing water stream is not claimed.

EP 2 559 473 A1 discloses a process for purifying a nitrosamine-contaminated, CO₂-comprising product of a process plant in which the contaminated product is irradiated with UV radiation in such a manner that the nitrosamines are destroyed. A CO₂ capture plant is described, wherein a UV light source can be arranged in the condensate return line from the condenser to the desorber. The concentration of nitrosamines expected in the desorber condensate, however, is low, since the nitrosamines present in the flash steam in the upper region of the desorber are expelled by the returned condensate. The arrangement of the UV light source in the condensate return line to the desorber therefore does not lead to an efficient decrease of the amount of nitrosamine in the absorbent circuit.

The object of the present invention is to specify a process for separating off acid gases from a nitrogen oxide-comprising fluid stream, in particular for removing acid gases from a flue gas, which permits efficient degradation of nitrosamines.

The object is achieved by a process for separating off acid gases from a nitrogen oxide-comprising fluid stream, wherein
a) the fluid stream is brought into contact in an absorption zone with an aqueous absorbent which comprises at least one amino group-comprising compound, wherein a deacidified fluid stream is obtained,
b) the deacidified fluid stream is brought into contact in at least one scrubbing zone with an aqueous scrubbing liquid and a de-aminated deacidified fluid stream is obtained, wherein the scrubbing liquid is recycled via at least one scrubbing zone,
c) overflow from the at least one scrubbing zone is treated with UV light, and
d) the UV-treated overflow is combined with the absorbent.

The nitrogen oxide-comprising fluid stream is brought into contact in an absorption zone with the aqueous absorbent which comprises at least one amino group-comprising compound. In the process, an at least partially deacidified fluid stream (in the present case termed deacidified fluid stream) is obtained and an absorbent loaded with acid gases. The fluid stream is preferably treated with the absorbent in counterflow. The fluid stream in this case is generally fed into a lower region and the absorbent into an upper region of the absorption zone. For improving the contact and providing a large mass-transfer interface, the absorption zone generally comprises internals, e.g. random packings, ordered packings and/or trays. The fluid stream is treated with the absorbent in a suitable manner in an absorption tower or absorption column, e.g. a random packing, ordered packing or tray column. The section of an absorption column in which the fluid stream comes into mass-transfer contact with the absorbent is considered to be the absorption zone.

The temperature of the absorbent introduced into the absorption zone is generally about 20 to 60° C.

The deacidified fluid stream is then brought into contact in at least one scrubbing zone with an aqueous scrubbing liquid, in order to transfer entrained amino group-comprising compound at least in part to the scrubbing liquid. In this case a de-aminated deacidified fluid stream is obtained and a scrubbing liquid loaded with amino group-comprising compound. Scrubbing the deacidified fluid stream with the aqueous scrubbing liquid permits removal of the majority of the entrained amino group-comprising compound, optionally entrained decomposition products of the amino group-comprising compound and nitrosamines.

Aqueous liquids suitable as aqueous scrubbing liquid are those substantially free from amino group-comprising compounds and decomposition products thereof. Typically, the scrubbing liquid comprises less than 2% by weight, preferably less than 1% by weight, particularly preferably less than 5000 ppm by weight, of amino group-comprising compound such as amines, and decomposition products thereof. The scrubbing liquid can be intrinsic liquids, i.e. aqueous liquids which arise at a different position of the process, or externally supplied aqueous liquids.

Suitably, the absorption zone is arranged in an absorption column and the scrubbing zone(s) are constructed as section(s) of the absorption column that are arranged above the absorption zone. The scrubbing zones for this purpose are a section of the absorption column constructed as a backwash section above the feed-in of the absorbent.

In the scrubbing zones, the scrubbing liquid is conducted against the deacidified fluid stream in counterflow. Preferably, the scrubbing zones comprise random packings, ordered packings and/or trays, in order to intensify the contact of the fluid stream with the scrubbing liquid. The scrubbing liquid can be distributed over the cross section of the scrubbing zone above the scrubbing zone by suitable liquid distributors.

The scrubbing liquid is recycled via at least one scrubbing zone. The scrubbing liquid for this purpose is collected beneath the scrubbing zone, e.g. by means of a suitable collecting tray, and pumped via a pump to the top end of the scrubbing zone. The recycled scrubbing liquid can be cooled, preferably to a temperature of 20 to 70° C., in particular 30 to 60° C. For this purpose, the scrubbing liquid is expediently circulated by pumping via a cooler.

In order to avoid accumulation in the scrubbing liquid of absorbent components that have been extracted by scrubbing, at least one substream of the scrubbing liquid is passed out of the scrubbing zone as overflow. Overflow is taken to mean the (sub)stream of the aqueous scrubbing liquid which is ejected from the scrubbing liquid circuit.

In one embodiment, the deacidified fluid stream flows through a plurality of scrubbing zones sequentially. The first scrubbing zone is considered to be the scrubbing zone in which the deacidified fluid stream is brought into contact for the first time with the aqueous scrubbing liquid.

A plurality of scrubbing zones are preferably connected as a cascade, i.e. overflow from one scrubbing zone is passed into the preceding scrubbing zone. The scrubbing liquid is recycled via at least one scrubbing zone of the cascade; the cascade can comprise one or more scrubbing zones without recycling, i.e. scrubbing zones through which the scrubbing liquid passes in “straight passage”. Preferably, overflow from the first scrubbing zone is treated according to the invention with UV light.

The ratio of the volumetric flow rate of the scrubbing liquid recycled via a single scrubbing zone to the volumetric flow rate of the overflow is termed the recycling ratio. The recycling ratio of the scrubbing zone situated furthest upstream with respect to the direction of flow of the deacidified fluid stream and via which aqueous scrubbing liquid is recycled is generally 5 to 100, preferably 10 to 80, particularly preferably 20 to 70.

Suitably, the first scrubbing zone of a cascade is arranged immediately above the absorption zone in an absorption column, and the further scrubbing zones are arranged above the first scrubbing zone. In this arrangement, the “scrubbing zone situated furthest upstream with respect to the direction of flow of the deacidified fluid stream and via which aqueous scrubbing liquid is recycled” is the lowest scrubbing zone via which aqueous scrubbing liquid is recycled.

In a preferred embodiment, the deacidified fluid stream is conducted through a first scrubbing zone and then conducted through a second scrubbing zone, wherein aqueous scrubbing liquid is recycled via the second scrubbing zone, overflow from the second scrubbing zone is conducted through the first scrubbing zone without recycling and overflow from the first scrubbing zone is treated with UV light. The recycling ratio of the second scrubbing zone (i.e. the “scrubbing zone situated furthest upstream with respect to the direction of flow of the deacidified fluid stream and via which aqueous scrubbing liquid is recycled”) is generally 5 to 100, preferably 10 to 80, particularly preferably 20 to 70.

In an alternative embodiment, the deacidified fluid stream is conducted through a first scrubbing zone and then conducted through a second scrubbing zone, wherein aqueous scrubbing liquid is recycled via each scrubbing zone, overflow from the second scrubbing zone is passed into the first scrubbing zone and overflow from the first scrubbing zone is treated with UV light. The recycling ratio of the first scrubbing zone is generally 5 to 100, preferably 10 to 80, particularly preferably 20 to 70.

Steam, which is entrained by the deacidified fluid stream, can be condensed in at least one scrubbing zone and increase the volume of the aqueous scrubbing liquid. This can be effected by cooling the fluid stream in the scrubbing zone, i.e. by cooling the recycled scrubbing liquid. The volumetric flow rate of the overflow of a scrubbing zone may thus be adjusted by the temperature to which the scrubbing liquid is cooled. Generally, in addition, feed water is introduced into a scrubbing zone, in the case of a cascade of scrubbing zones, preferably into the last scrubbing zone, in order to compensate for the loss of volume of the scrubbing liquid via the discharged overflow. Preferably, the feed water comprises at least in part freshwater. Freshwater is considered to be water, e.g. superheated steam condensate, which does not comprise significant amounts of absorbent components. Preferably, the amount of freshwater substantially corresponds to the amount of water loss of the absorbent circuit (makeup water), in order not to impair the water balance of the absorbent circuit and to prevent an accumulation of water.

Desorber overhead condensate can also be passed to the scrubbing zone. The use of the desorber overhead condensate as additional aqueous liquid is preferred, because it is without consequence for the water balance of the overall system and this aqueous phase is substantially free from impurities via an amino group-comprising compound.

According to the invention, overflow from the (first) scrubbing zone is treated with UV light. The treatment of the overflow with UV light degrades at least a part of the nitrosamines present therein. The scrubbing liquid contains only small amounts of amino group-comprising compounds, e.g. amines. In the scrubbing liquid, therefore, there is only a slight absorption of the UV light due to amino group-comprising compounds, e.g. amines, and the UV light displays a large depth of penetration into the scrubbing liquid. Nitrosamines can be effectively degraded. Surprisingly, treatment of the comparatively low volumetric flow rate at the overflow is sufficient in order to act as a nitrosamine sink and to prevent accumulation of nitrosamines in the overall absorbent circuit.

UV light is taken to mean in the present case electromagnetic radiation having at least a wavelength in the range from 100 to 380 nm. The treatment can proceed using polychromatic or monochromatic UV light. Preferably, the treatment proceeds using polychromatic UV light.

Electromagnetic radiation having a wavelength in the range from 100 to 200 nm (vacuum UV light) can lead to undesirable decomposition of amino group-comprising compounds present in the scrubbing liquid and promote undesirable side reactions. Preferably, the ratio of the intensity of the UV light in the wavelength range from 220 to 380 nm to the intensity of the UV light in the wavelength range from 100 to 380 nm, therefore, is at least 0.85, preferably at least 0.90. More preferably the ratio of the sum of the intensities of the UV light in the wavelength ranges from 220 to 280 nm and 320 to 380 nm to the intensity of the UV light in the wavelength range from 100 to 380 nm is at least 0.85, preferably at least 0.90. Preferably, the ratio of the sum of the intensities of the UV light in the wavelength ranges from 230 to 250 nm and 330 to 360 nm to the intensity of the UV light in the wavelength range from 100 to 380 nm is at least 0.85, preferably at least 0.90. The intensity of the UV light in a wavelength range is taken to mean the integral over the spectral intensity in the wavelength range.

The treatment with UV light can proceed either continuously, or else by light pulses or light flashes.

The irradiance is preferably at least 10⁻⁶ W/cm², preferably at least 5×10⁻⁶ and particularly preferably 5-50×10⁻⁶ W/cm². The calculation of the irradiance incorporates, as power, the energy expended for the treatment per unit time in the form of UV light. If the treatment proceeds via light pulses or flashes, the power incorporated is the power averaged over the entire treatment period. The area incorporated is the surface area through which the UV light impacts the scrubbing liquid.

Preferably, the overflow is treated with UV light in a reaction zone. The length of the treatment with UV light is preferably 10 seconds to 10 minutes, particularly preferably 20 seconds to 7.5 minutes, particularly preferably 30 seconds to 5 minutes. The length of the treatment is defined as the residence time in the reaction zone. The residence time in the reaction zone is determined by dividing the volume of the reaction zone by the volumetric flow rate of the overflow. For example, for a volume of the reaction zone of 10 liters and a volumetric flow rate of the overflow of 5 liters per minute, a length of treatment of 2 minutes is obtained.

The path length which the UV light travels in the overflow can be increased using reflective surfaces.

Preferably, the UV light is provided by at least one electric light source. Preferably, as electric light source, a UV light-emitting gas discharge lamp, a UV light-emitting diode or a UV laser is used. Particularly preferably, as electric light source, a UV light-emitting gas discharge lamp is used.

Preferred UV light-emitting gas discharge lamps comprise a mercury vapor-comprising filling. Further preference is given to mercury vapor low-pressure and mercury vapor medium-pressure lamps.

The reaction zone is preferably arranged in a reactor. The reactor preferably has two connections, wherein the overflow is conducted into the reactor through one of the connections, treated with the UV light in the reaction zone and removed from the reactor via the other connection.

The electric light source for providing the UV light can be arranged outside the reactor. At least a part of the reactor is then permeable to UV light. Preferably, the UV light-permeable part of the reactor comprises a solid permeable to UV light, e.g. quartz glass which is integrated into a wall of the reactor as a window. Preferably, as great as possible a part of the UV light provided by the light source is used for treating the overflow. In order to ensure utilization of a large part of the UV light provided by a light source, reflective surfaces can be mounted outside the light source, via which at least a part of the UV light passes into the reaction zone. A light source which predominantly emits the UV light in one direction can be arranged in such a manner that the UV lightpasses virtually completely into the reaction zone via the UV light-permeable part of the reactor. Such a light source can comprise e.g. internally arranged reflective surfaces.

Preferably, the electric light source for providing the UV light is arranged in the reactor. As a light source arranged in the reactor, preferably, a UV light-emitting gas discharge lamp, a UV light-emitting diode or a UV laser can be used. Particularly preferably, as light source arranged in the reactor, a UV light-emitting gas discharge lamp is used.

The UV-treated overflow is then combined with the absorbent. It can be introduced into the absorbent circuit at any desired point. The UV-treated overflow can be combined, e.g., with the regenerated absorbent and/or the loaded absorbent. In one embodiment, the UV-treated scrubbing liquid is passed into the absorption zone. Alternatively, the UV-treated scrubbing liquid can be passed into the desorption zone or the bottom-phase of the desorption column.

Generally, the absorbent loaded with acid gases is regenerated in a desorption zone by heating with partial evaporation of the absorbent, wherein the acid gases are at least in part liberated, and a regenerated absorbent is obtained. Preferably, an absorbent circuit is formed by returning the regenerated absorbent to step a).

Preferably, the liberated acid gases are cooled, in order to condense at least in part entrained steam. The condensate (termed desorber overhead condensate) can be conducted at least in part into the scrubbing zone as feed water. The use of this condensate as feed water has the advantage that it does not impair the water balance of the absorbent circuit. On the other hand, the condensate, depending on the conditions prevailing in the desorption zone, can comprise amino group-comprising compound from the absorbent, in such a manner that the scrubbing action of the condensate is limited and very low concentrations of amino group-comprising compound in the de-aminated deacidified fluid stream cannot be achieved. The (exclusive) use of the condensate as feed water is therefore generally not preferred.

The liberated acid gases can be passed through an enrichment zone before they are cooled. In the enrichment zone, traces of the amino group-comprising compound entrained with the liberated acid gases and nitrosamines are expelled by the reflux of part of the desorber overhead condensate, in such a manner that the acid gases exiting at the top of the enrichment zone are substantially free from amino group-comprising compound. A substream of the condensate preferably may then be used as feed water.

A further purification of the de-aminated, deacidified fluid stream for removing the last traces of amino group-comprising compound, in particular amine, succeeds in one embodiment in which the de-aminated, deacidified fluid stream is then scrubbed with an acidic aqueous solution. For this purpose the de-aminated, deacidified fluid stream can be conducted through a scrubbing zone, preferably in a scrubbing column, e.g. a random packing, ordered packing and tray column, via which the acidic aqueous solution is recycled.

Suitable acids are inorganic or organic acids, such as sulfuric acid, sulfurous acid, phosphoric acid, nitric acid, acetic acid, formic acid, carbonic acid, citric acid and the like. Preferably, the acid used has a pKa value of −4 to 7. The preferred pH of the acidic aqueous solution is 3 to 7, in particular 4 to 6.

A suitable acidic aqueous solution is, in particular, acidic process waters. Such acidic process waters arise, in particular, in the treatment of sulfur dioxide-comprising gases, e.g. in an SO₂ prepurification step. For instance, in the cooling or pre-scrubbing of sulfur dioxide-comprising gases an acidic condensate is obtained which can be used as acidic process water.

Owing to the absorption of amino group-comprising compound into the acidic aqueous solution, the concentration of the amino group-comprising compound in the acidic aqueous solution increases. In order to avoid excessive concentrations of dissolved salts in the acidic aqueous solution, expediently, a substream of the acidic aqueous solution is discharged and it is replaced by fresh acidic aqueous solution. Amino group-comprising compound or decomposition products thereof, such as ammonia, can be at least partially recovered from the discharged substream. For this purpose, the discharged aqueous solution can be treated with an alkali, e.g. sodium hydroxide, wherein amine or amine decomposition products are liberated.

Alternatively, the discharged aqueous solution can be discarded or fed to a wastewater treatment.

The absorbent comprises at least one amino group-comprising compound.

Depending on the pH of the absorbent, the amino group-comprising compound can also be present in partially protonated form (as ammonium group-comprising compound).

Suitable amino group-comprising compounds are (i) amines or combinations of amines, (ii) metal salts of aminocarboxylic acids, (iii) combinations of amines and aminocarboxylic acids, or (iv) combinations of amines and metal salts of aminocarboxylic acids.

Preferred amines are the following:

(i) amines of the formula (I):

NR¹(R²)₂ (I)

where R¹ is selected from C₂-C₆-hydroxyalkyl groups, C₁-C₆-alkoxy-C₂-C₆-alkyl groups, hydroxy-C₁-C₆-alkoxy-C₂-C₆-alkyl groups and 1-piperazinyl-C₂-C₆-alkyl groups and R² is selected independently from H, C₁-C₆-alkyl groups and C₂-C₆-hydroxyalkyl groups;

(ii) amines of the formula (II)

R³R⁴N—X—NR⁵R⁶ (II)

where R³, R⁴, R⁵ and R⁶ independently of one another are selected from H, C₁-C₆-alkyl groups, C₂-C₆-hydroxyalkyl groups, C₁-C₆-alkoxy-C₂-C₆-alkyl groups and C₂-C₆-aminoalkyl groups and X is a C₂-C₆-alkylene group, —X¹—NR⁷—X²— or —X¹—O—X²—, where X¹ and X² independently of each other are C₂-C₆-alkylene groups and R⁷ is H, a C₁-C₆-alkyl group, C₂-C₆-hydroxyalkyl group or C₂-C₆-aminoalkyl group; and

(iii) 5- to 7-membered saturated heterocycles having at least one nitrogen atom in the ring, which can contain one or two further heteroatoms in the ring selected from nitrogen and oxygen, and

(iv) mixtures thereof.

Specific examples are

(i) 2-aminoethanol(monoethanolamine), 2-(methylamino)ethanol, 2-(ethylamino)ethanol, 2-(n-butylamino)ethanol, 2-amino-2-methylpropanol, N-(2-aminoethyl)piperazine, methyldiethanolamine, ethyldiethanolamine, dimethylaminopropanol, t-butylaminoethoxyethanol, 2-aminomethylpropanol;

(ii) 3-methylaminopropylamine, ethylenediamine, diethylenetriamine, triethylenetetramine, 2,2-dimethyl-1,3-diaminopropane, hexamethylenediamine, 1,4-diaminobutane, 3,3-iminobispropylamine, tris(2-aminoethyl)amine, bis(3-dimethylaminopropyl)amine, tetramethylhexamethylenediamine;

(iii) piperazine, 2-methylpiperazine, N-methylpiperazine, 1-hydroxyethylpiperazine, 1,4-bis(hydroxyethyl)piperazine, 4-hydroxyethylpiperidine, homopiperazine, piperidine, triethylenediamine, 2-hydroxyethylpiperidine and morpholine; and

(iv) mixtures thereof.

Particularly preferred amines have at least one secondary amino group. Particular preference is given to the following:

(i) amines of the above formula (I), wherein one radical R² is H and the other radical R² is a radical different from H;

(ii) amines of the above formula (II), wherein
R³ is H and R⁴ is a radical different from H,
and/or
X is —X¹—NR⁷—X²— and R⁷ is H;

(iii) 5- to 7-membered saturated heterocycles having at least one NH group in the ring, which can comprise one or two further heteroatoms in the ring selected from nitrogen and oxygen.

Specific examples of preferred amines which have at least one secondary amino group are:

(i) diisopropylamine, diethanolamine, 2-(methylamino)ethanol, 2-(ethylamino)ethanol, 2-(n-butylamino)ethanol, t-butylaminoethoxyethanol;

(ii) 3-methylaminopropylamine, diethylenetriamine, triethylenetetramine, 3,3-iminobispropylamine, bis(3-dimethylaminopropyl)amine, tetramethylhexamethylenediamine; and

(iii) piperazine, 2-methylpiperazine, N-methylpiperazine, 1-hydroxyethylpiperazine, 4-hydroxyethylpiperidine, homopiperazine, piperidine and morpholine.

In a preferred embodiment, the absorbent comprises at least one of the secondary amines 3-methylaminopropylamine (MAPA), piperazine, diethanolamine (DEA) or diisopropylamine (DIPA).

Particularly preferred absorbents comprise

methyldiethanolamine and at least one amine selected from piperazine and 1-hydroxyethylpiperazine; or

methyldiethanolamine and 3-methylaminopropylamine; or

triethylenediamine and at least one amine selected from piperazine and 1-hydroxyethylpiperazine; or

triethylenediamine and 3-methylaminopropylamine; or

dimethylaminopropanol and at least one amine selected from piperazine and 1-hydroxyethylpiperazine; or

dimethylaminopropanol and 3-methylaminopropylamine.

Aminocarboxylic acids comprise at least one amino group and at least one carboxyl group in the molecular structure thereof.

Preferred aminocarboxylic acids are the following:

α-amino acids, such as glycine (aminoacetic acid), N-methylglycine (N-methylaminoacetic acid, sarcosine), N,N-dimethylglycine (dimethylaminoacetic acid), N-ethylglycine, N,N-diethylglycine, alanine (2-aminopropionic acid), N-methylalanine (2-(methylamino)propionic acid), N,N-dimethylalanine, N-ethylalanine, 2-methylalanine (2-aminoisobutyric acid), leucine (2-amino-4-methylpentan-1-oic acid), N-methylleucine, N,N-dimethylleucine, isoleucine (1-amino-2-methylpentanoic acid), N-methylisoleucine, N,N-dimethylisoleucine, valine (2-aminoisovaleric acid), α-methylvaline (2-amino-2-methylisovaleric acid), N-methylvaline (2-methylaminoisovaleric acid), N,N-dimethylvaline, proline (pyrrolidine-2-carboxylic acid), N-methylproline, serine (2-amino-3-hydroxypropan-1-oic acid), N-methylserine, N,N-dimethylserine, 2-(methylamino)isobutyric acid, piperidine-2-carboxylic acid, N-methylpiperidine-2-carboxylic acid,

β-amino acids, such as 3-aminopropionic acid (β-alanine), 3-methylaminopropionic acid, 3-dimethylaminopropionic acid, iminodipropionic acid, N-methyliminodipropionic acid, piperidine-3-carboxylic acid, N-methylpiperidine-3-carboxylic acid,

or aminocarboxylic acids such as piperidine-4-carboxylic acid, N-methylpiperidine-4-carboxylic acid, 4-aminobutyric acid, 4-methylaminobutyric acid, 4-dimethylaminobutyric acid.

The metal salt is generally an alkali metal salt or alkaline earth metal salt, preferably an alkali metal salt, such as a sodium or potassium salt, of which potassium salts are the most preferred.

Particularly preferred metal salts of aminocarboxylic acids are the potassium salt of dimethylglycine or N-methylalanine.

The amino group-comprising compound can also be an aminocarboxylic acid which is present in addition to an amine in the absorbent. Preferably, the amino group-comprising compound is then one of said aminocarboxylic acids.

Generally, the absorbent comprises 10 to 60% by weight of amino group-comprising compound.

The absorbent can also comprise additives, such as corrosion inhibitors, enzymes, etc. Generally, the amount of such additives is in the range of about 0.01-3% by weight of the absorbent.

The process according to the invention is suitable for treating nitrogen oxide-comprising fluid streams. The nitrogen oxide-comprising fluid stream is preferably oxidation offgas.

The oxidation, from which the oxidation offgas originates, can be carried out with appearance of flames, i.e. as conventional combustion, or as oxidation without appearance of flames, e.g. in the form of a catalytic, oxidation or partial oxidation. Organic substances which are subjected to the combustion are fossil fuels such as coal, natural gas, petroleum, gasoline, diesel, raffinates or kerosene, biodiesel or waste materials comprising organic substances. Starting materials of the catalytic (partial) oxidation are e.g. methanol or methane, which can be reacted to form formic acid or formaldehyde.

The oxidation offgas can also be an oxidation offgas originating from the microbial oxidation of organic substances. The oxidation offgas originating from the microbial oxidation of organic substances is e.g. a gas which originates from the composting of organic substances.

In a particularly preferred embodiment of the process, the nitrogen oxide-comprising fluid stream is a flue gas. Flue gas in the meaning of this document is an oxidation offgas which originates e.g. from the combustion of coal, natural gas, petroleum, gasoline, diesel, raffinates or kerosene, biodiesel or waste materials comprising organic substances. Preferably, the oxidation offgas originates from the combustion of coal, natural gas, petroleum or waste materials comprising organic substances.

The combustion proceeds preferably with air in usual combustion facilities. The flue gas of such facilities can advantageously be treated by the process according to the invention.

Before the fluid stream is contacted in the absorption zone with the absorbent, the fluid stream, e.g. flue gas, is preferably subjected to a scrubbing with an aqueous liquid, in particular with water, in order to cool and moisten (quench) the fluid stream. During the scrubbing, dust or gaseous impurities such as sulfur dioxide can also be removed. During the treatment of sulfur dioxide-comprising gases, in this manner an acidic process water is obtained which can be used as a previously described acidic aqueous solution.

Before the fluid stream, e.g. flue gas, is contacted in the absorption zone with the absorbent, in addition, the concentration of the nitrogen oxides present in the fluid stream is preferably decreased. The fluid stream can be contacted e.g. with ammonia, wherein nitrogen is formed from the nitrogen oxides and the ammonia by synproportionation.

The invention is described in more detail by the accompanying drawings and the examples hereinafter.

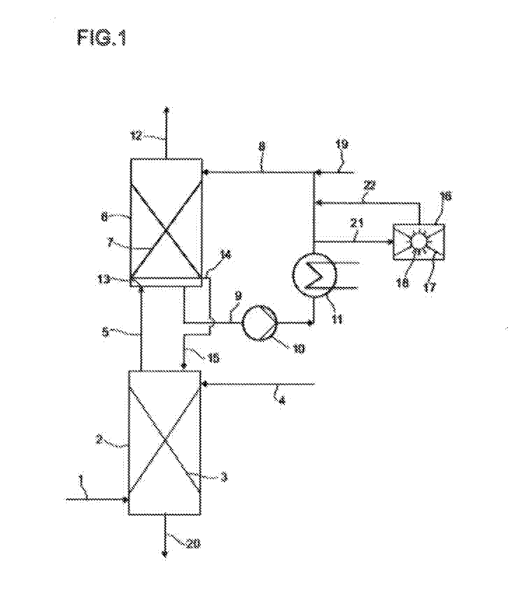

FIG. 1 shows schematically a facility for carrying out a process not according to the invention, wherein a part of the aqueous scrubbing liquid recycled via the scrubbing zone is treated with UV light.

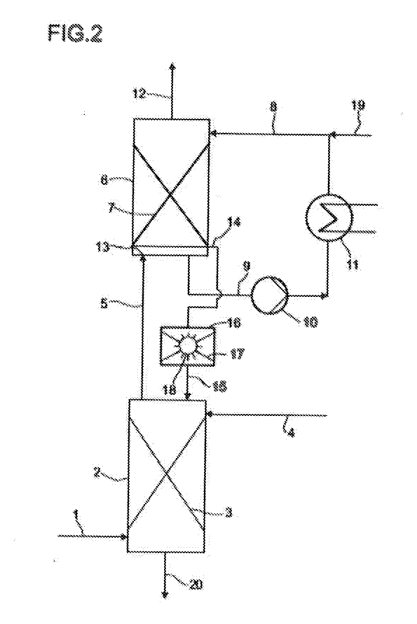

FIG. 2 shows schematically a facility for carrying out the process according to the invention, wherein the overflow from the scrubbing zone is treated with UV light.

In accordance with FIG. 1, a nitrogen oxide-comprising fluid stream 1 is passed into the lower part of an absorber 2. The absorber 2 has an absorption zone 3. In the absorption zone 3, the nitrogen oxide-comprising fluid stream is contacted in counterflow with an absorbent which is introduced into the absorber 2 via the line 4 above the absorption zone. The deacidified fluid stream 5 is passed into the lower part of a scrubbing unit 6. The scrubbing unit 6 has a scrubbing zone 7. In the scrubbing zone 7, the deacidified fluid stream is contacted in counterflow with an aqueous scrubbing liquid which is introduced into the scrubbing unit 6 above the scrubbing zone via the line 8. In the lower region of the scrubbing zone, the aqueous scrubbing liquid is collected on a collecting tray 13 and recycled via line 9, cooler 11 and line 8 with the aid of the pump 10. Feed water is introduced into the aqueous scrubbing liquid via line 19 and fed into the scrubbing zone with the aqueous scrubbing liquid. A de-aminated, deacidified fluid stream is conducted out of the scrubbing unit via line 12. Overflow from the scrubbing zone is removed via a takeoff 14 mounted above the collecting tray 13 and passed into the absorber via line 15. Via line 20, an absorbent loaded with acid gases is taken off from the absorber below the absorption zone.

A substream of the aqueous scrubbing liquid is conducted via line 21, the reactor 16 and line 22. The reactor 16 has a reaction zone 17 in which the substream of the aqueous scrubbing liquid is treated with UV light which is provided by a UV light source 18.

In FIG. 2, the same reference signs have the same meaning as in FIG. 1. In contrast to FIG. 1, lines 21 and 22 are not provided. Instead, the overflow removed via the takeoff 14 is conducted through the reactor 16 and from the reactor via line 15 into the absorber.

### EXAMPLES

Calculations were carried out on the basis of FIGS. 1 and 2.

The calculations were based, as absorption zone 3, on an absorber column having a random packing of 20 m in length and a diameter of 1 m which comprised a mass constant with time of 800 kg of absorbent. A formation rate of 0.06 mg of nitrosamine per kg of absorbent per hour was assumed.

For the calculations, a deacidified fluid stream 5 of 3700 kg per hour having a temperature of 60° C. was taken into consideration. A temperature of 40° C. was assumed for the de-aminated deacidified fluid stream conducted via line 12 from the scrubbing unit.

A volumetric flow rate of the absorbent and of the aqueous scrubbing liquid in each case of 13 m³ per hour was used in the calculations.

A stream of 405 kg per hour was assumed for the feed water introduced via line 19 in the aqueous scrubbing liquid, with the water loss occurring via gas streams 1 and 12 (and the CO₂ product stream at the desorber head which is not shown in the figures) being completely compensated for by said stream.

It was assumed that the mass fraction of the nitrosamine in the absorbent is higher by the factor 2000 than the mass fraction of the nitrosamine in the deacidified fluid stream (5).

In addition, it was assumed that the nitrosamines were 100% degraded in the reactor; i.e. the stream exiting from the reactor 16 was free of nitrosamine.

In table 1, the results of the calculations are shown which occur in the steady state.

TABLE 1

| Process according to | FIG. 1* | | | FIG. 2 |
|---|---|---|---|---|
| Flow through the reactor [kg/h] | 1000 | 2000 | 3000 | 405 |
| Overflow [kg/h] | 405 | 405 | 405 | 405 |
| Nitrosamine content in the | 43 | 32 | 30 | 26 |
| absorbent [mg/kg] | | | | |

*Not according to the invention

The examples show that the stream treated with UV light in the process according to the invention is substantially smaller, at 405 kg/h, than that in the process according to FIG. 1 that is not according to the invention. In the process according to FIG. 1 the nitrosamine content in the absorbent, even at a UV light-treated stream of 3000 kg/h, is higher than in the process according to the invention.

Accordingly, in the process according to the invention, a smaller reactor 16 can be used, the energy expended for the treatment with UV light can be reduced and a smaller UV light source can be used.

1. A process for separating off-acid gases from a fluid stream that includes nitrogen oxide the process comprising;
a) contacting the fluid stream in an absorption zone with an aqueous absorbent that includes at least one amino group-comprising compound to provide a deacidified fluid stream,
b) contacting the deacidified fluid stream in at least one scrubbing zone with an aqueous scrubbing liquid and a de-aminated, deacidified fluid stream, wherein the scrubbing liquid is recycled via at least one scrubbing zone,
c) treating overflow from the at least one scrubbing zone with UV light, and
d) combining the UV-treated overflow with the aqueous absorbent.

2. The process according to claim 1, wherein the contacting of the deacidified fluid stream with an aqueous scrubbing liquid is conducted in a cascade of scrubbing zones.

3. The process according to claim 2, wherein the deacidified fluid stream is conducted through a first scrubbing zone and then conducted through a second scrubbing zone, wherein aqueous scrubbing liquid is recycled via the second scrubbing zone, overflow from the second scrubbing zone is conducted through the first scrubbing zone without recycling and overflow from the first scrubbing zone is treated with UV light.

4. The process according to claim 2, wherein the deacidified fluid stream is conducted through a first scrubbing zone and then conducted through a second scrubbing zone, wherein aqueous scrubbing liquid is recycled via each scrubbing zone, overflow from the second scrubbing zone is passed into the first scrubbing zone and overflow from the first scrubbing zone is treated with UV light.

5. The process according to claim 2, wherein a recycling ratio of the scrubbing zone situated furthest upstream with respect to the direction of flow of the deacidified fluid stream is 5 to 100.

6. The process according to claim 1, wherein a ratio of the intensity of the UV light in the wavelength range from 220 to 380 nm to the intensity of the UV light in the wavelength range from 100 to 380 nm is at least 0.85.

7. The process according to claim 1, wherein the absorption zone is arranged in an absorption column and the at least one scrubbing zone is constructed as a section of the absorption column arranged above the absorption zone.

8. The process according to claim 2, further comprising passing feed water into the last scrubbing zone.

9. The process according to claim 8, wherein the feed water comprises at least in part freshwater.

10. The process according to claim 9, wherein the amount of freshwater substantially corresponds to the amount of water loss of the absorbent circuit.

11.-13. (canceled)

14. The process according to claim 1, wherein the absorbent comprises at least one amine which comprises at least one secondary amino group.

15. The process according to claim 1, wherein the fluid stream is a flue gas stream.

16. The process according to claim 2, wherein the aqueous absorbent loaded with acid gases is regenerated in a desorption zone by heating with partial evaporation of the absorbent, wherein the acid gases are at least in part liberated.

17. The process according to claim 16, further comprising cooling the liberated acid gases to condense at least in-part entrained steam, and the condensate is passed at least in part as feed water to the last scrubbing zone.

18. The process according to claim 1, further comprising scrubbing the de-aminated, deacidified fluid stream with an acidic aqueous solution.
